(19) United States
(12) Patent Application Publication
(10) Pub. No.: US 2008/0259212 A1
(43) Pub. Date: Oct. 23, 2008

(54) VIDEO SIGNAL PROCESSING APPARATUS AND RE-SAMPLING APPARATUS

(75) Inventor: Hiroyuki FUKUMORI, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC ELECTRONICS CORPORATION, Kanagawa (JP)

(21) Appl. No.: 12/105,475

(22) Filed: Apr. 18, 2008

(30) Foreign Application Priority Data
Apr. 20, 2007 (JP) 2007-111173

(51) Int. Cl. H04N 9/45

(52) U.S. Cl. 348/505; 348/E09.03

(57) ABSTRACT

A video signal processing apparatus comprises a component video signal demodulator to demodulate a component video signal sampled by a burst lock clock signal from a composite video signal sampled by the burst lock clock signal, the burst clock signal having multiplied frequency of a color subcarrier in the composite video signal having an auxiliary digital data signal inserted therein, and a re-sampling unit to convert sampling frequency of the component video signal selectively to a first frequency equal to or multiplied by horizontal synchronization frequency of the composite video signal or to a second frequency equal to or multiplied by frequency of the auxiliary digital data signal.

### BACKGROUND OF THE INVENTION

1. Field of the Invention

The present invention relates to a video signal processing apparatus for converting a composite video signal into a component video signal and particularly to a video signal processing apparatus which converts a sampling frequency of the video signals to extract auxiliary digital data inserted in the composite video signal.

2. Description of Related Art

In order to reproduce images of high quality from the composite video signal, a burst lock clock synchronous with a color burst signal is used as an operation clock signal for signal processing for converting the composite video signal into a component video signal (specifically, Y/C separation and color demodulation). The burst lock clock is a clock signal of frequency that is a multiple of, e.g. four or eight times, the color burst frequency (i.e., color subcarrier frequency) f_{sc}.

Meanwhile, a line lock clock synchronous with a horizontal synchronization signal is used as an operation clock for outputting a video signal in digital form of ITU-R BT.601 format or the like for video signal processing performed on a per scan line basis such as progressive conversion. For example, in the case of the NTSC standard, if the frequency of the line lock clock is set at 910 or 1820 times a horizontal synchronization frequency fH, it becomes the same as the frequency of the burst lock clock because 910 fH equals 4 f_{sc}. However, because the sampling frequency of a digital video signal specified in ITU-R BT.601 is 13.5 MHz, the sampling frequency is 858 fH for the NTSC standard and 864 fH for the PAL standard. Thus, the frequency of the line lock clock for when outputting a video signal in digital form of ITU-R BT.601 format or the like needs to be 858 fH or a multiple thereof for the NTSC standard and 864 fH or a multiple thereof for the PAL standard.

Hence, a video signal processing apparatus for performing a series of video signal processes from demodulating an analog composite video signal into a component video signal to outputting in digital form, needs to sample the received analog composite video signal at the burst lock clock and perform Y/C separation and color demodulation on the sampled composite video signal, and thereafter perform re-sampling which converts the sampling frequency of the video signal sampled at the burst lock clock to the frequency of the line lock clock.

Further, the analog composite video signal transmitted from broadcast stations may have an auxiliary digital data signal inserted therein. To be specific, NRZ (Non Return to Zero) encoded EPG (Electronic Program Guide) data, teletext broadcasting data, teletext data, or the like is inserted in vertical blanking intervals (VBIs) of the composite video signal. Hereinafter, auxiliary digital data signals inserted in the VBI are collectively called a VBI data signal. Together with the VBI data signal, a CRI (Clock Run-In) signal for establishing bit synchronization with the VBI data signal and a framing code (FRC) for establishing frame synchronization are also inserted in the VBI.

A VBI data extracting apparatus (a so-called VB data slicer) for extracting the VBI data signal from the composite video signal or the component video signal sampled at the burst lock clock has been known. However, the frequencies of the burst lock clock and the line lock clock are not a multiple of the frequency of the VBI data signal specified in ITU-R BT.653, ETS300-706, ARIB SDT-B5, or the like. In order to accurately extract VBI data, bit determination is desirably performed at the center position of a data symbol where the eye opening is large, and the sampling frequency of the composite video signal or the component video signal from which to extract the VBI data signal is desirably a equal to or a multiple of the frequency of the VBI data signal.

In Japanese Patent Application Publication No. 8-223545 (Yoshimura et al.), a clock generator is disclosed which generates a VBI data extracting clock signal that is synchronous with the CRI (Clock Run-In) signal, for use in the extraction of VBI data.

The occurrence of digital errors associated with the extraction of VBI data is expected to be suppressed by sampling the video signal at the VBI data extracting clock synchronous with the VBI data signal, generated by the clock generator disclosed in Yoshimura et al. or the like to extract VBI data. However, there is the problem that it results in an increase in circuit scale to add the clock generator generating the VBI data extracting clock signal and an A/D converter sampling the analog composite video signal at the VBI data extracting clock as disclosed in Yoshimura et al. to a video signal processing apparatus.

### SUMMARY

In one embodiment, A video signal processing apparatus comprising a component video signal demodulator to demodulate a component video signal sampled by a burst lock clock signal from a composite video signal sampled by the burst lock clock signal, the burst clock signal having multiplied frequency of a color subcarrier in the composite video signal having an auxiliary digital data signal inserted therein, and a re-sampling unit to convert sampling frequency of the component video signal selectively to a first frequency equal to or multiplied by horizontal synchronization frequency of the composite video signal or to a second frequency equal to or multiplied by frequency of the auxiliary digital data signal.

By configuring the video signal processing apparatus in this way, a re-sampling circuit that produces a video signal sampled at the clock having frequency that is a multiple of the frequency of the auxiliary digital data signal (an auxiliary digital data extracting clock signal) and a re-sampling circuit that produces a video signal sampled at the clock having frequency that is a multiple of the horizontal synchronization frequency (the line lock clock) can be realized by the common configuration. Therefore, the clock generator generating the auxiliary digital data extracting clock signal and the A/D converter sampling the analog composite video signal at the auxiliary digital data extracting clock as disclosed in Yoshimura et al. need not be added to a video signal processing apparatus.

The video signal processing apparatus according to the present invention that demodulates the composite video signal having the auxiliary digital data signal inserted therein into the component video signal can suppress the occurrence of false determination when extracting the auxiliary digital data signal, and increase in the circuit scale of the video signal processing apparatus can be suppressed.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram showing the configuration of the video signal processing apparatus according to an embodiment 1 of the present invention;

FIG. 2 is a view showing the signal waveform of the composite video signal of the NTSC standard with the vertical blanking interval in which VBI data is inserted being centered;

FIG. 3 is a view showing an example configuration of the re-sampling unit included in the video signal processing apparatus according to the embodiment 1; and

FIG. 4 is a signal waveform diagram showing digital video signals in a video signal processing apparatus according to the embodiment 1.

### DETAILED DESCRIPTION OF THE PREFERRED EMBODIMENTS

The invention will now be described herein with reference to illustrative embodiments. Those skilled in the art will recognize that many alternative embodiments can be accomplished using the teachings of the present invention and that the invention is not limited to the embodiments illustrated for explanatory purposes.

A specific embodiment of the present invention will be described in detail below with reference to the drawings. The same elements in the drawings are indicated by the same reference numerals, and for clarification of description, duplicate description thereof will be omitted as needed.

### Embodiment 1

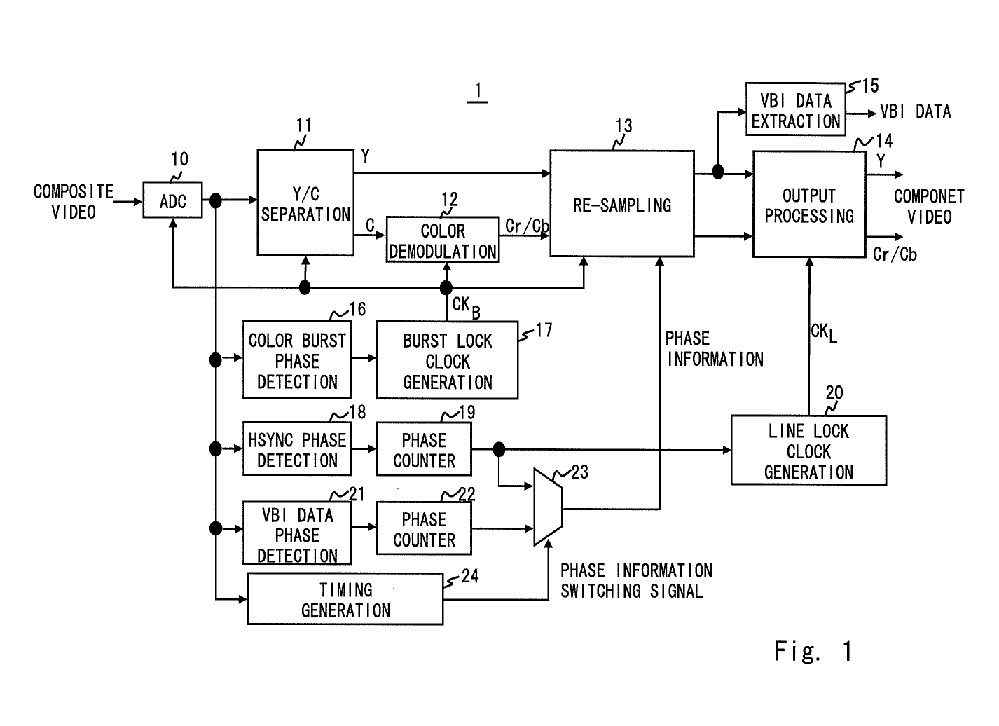

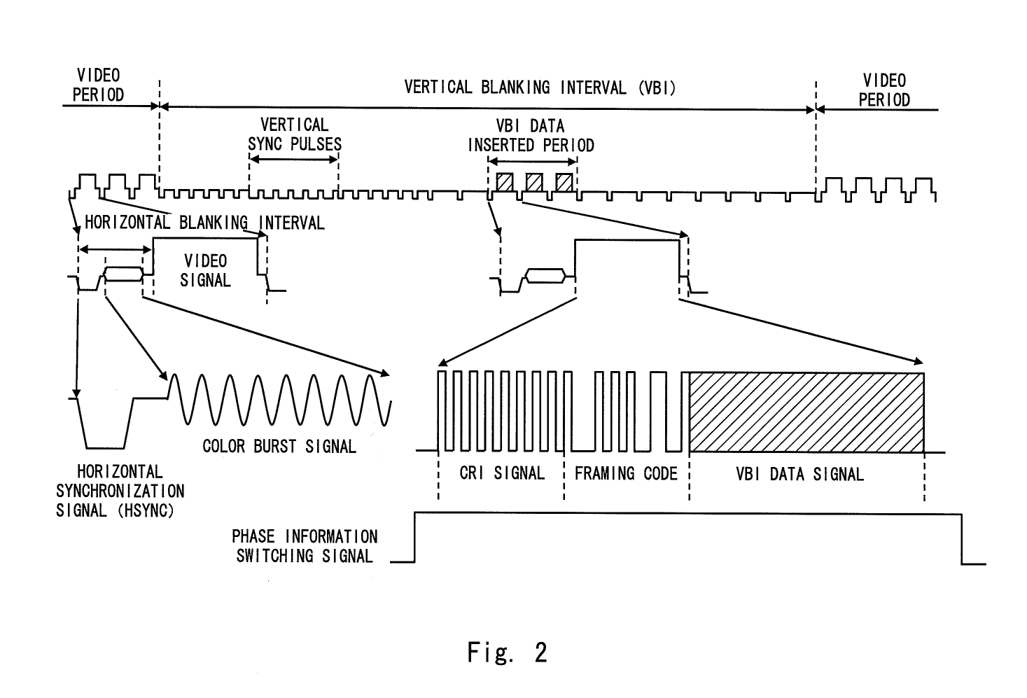

A video signal processing apparatus 1 according to the present embodiment converts the analog composite video signal into digital component video signal to be output and also extracts the VBI data inserted in the vertical blanking interval (VBI) of the analog composite video signal. FIG. 1 is a block diagram showing the configuration of the video signal processing apparatus 1 according to the present embodiment. In the description below, there is omitted a detailed description of known particulars such as the specification of various synchronization signals (a color burst signal, a horizontal synchronization signal, a vertical synchronization pulse, a CRI signal, etc.) inserted in the composite video signal, but the positions at which these signals are inserted are shown in FIG. 2. FIG. 2 shows the signal waveform of the composite video signal of the NTSC standard with the vertical blanking interval in which VBI data is inserted being centered.

In FIG. 1, an A/D converter 10 samples the input analog composite video signal at burst lock clock CK_{B} and outputs a digital signal. The burst lock clock CK_{B} is a clock signal synchronous with a color burst signal contained in the horizontal blanking interval of the analog composite video signal and is used as the operation clock for causing each part of the video signal processing apparatus 1 to operate. The frequency of the burst lock clock CK_{B} is set at 4 or 8 times the color subcarrier frequency f_{sc} for over sampling. For example, for the NTSC standard, 4 f_{sc} is at 14.3 MHz, which is 910 times the horizontal synchronization frequency, i.e., 910 fH. For the PAL standard, 4 f_{sc} is at 17.7 MHz, which is 1135 times the horizontal synchronization frequency, i.e., 1135 fH.

A Y/C separation unit 11 has input thereto the composite video signal sampled at the burst lock clock and separates this into a luminance signal Y and a color signal C. The Y/C separator 11 is embodied by a two-dimensional comb filter or a three-dimensional comb filter. In order to extract the VBI data inserted in the vertical blanking interval, the Y/C separation unit 11 stops Y/C separation during the vertical blanking interval to output the input signal as it is as the luminance signal Y.

A color demodulator 12 has input thereto the color signal C separated by the Y/C separation unit 11 and demodulates into color-difference signals Cr and Cb. The modulation method for the color signal C is different depending on the signal standard such as the NTSC standard or the PAL standard. Accordingly, in the case where the video signal processing apparatus 1 deals with video signals conforming to a plurality of different signal standards, the color demodulator 12 may be configured such that it can select a modulation method according to the input signal.

A re-sampling unit 13 has input thereto the digital component video signal sampled at the burst lock clock CK_{B}, that is, the luminance signal Y separated by the Y/C separation unit 11 and the color-difference signals Cr and Cb demodulated into by the color demodulator 12 and converts their sampling frequency. Further, the re-sampling unit 13 can select either line lock clock CK_{L} or VBI data extracting clock CK_{V} as the sampling frequency to be converted to.

To be specific, the re-sampling unit 13 re-samples the digital component video signal during the time period in which VBI data is inserted at the frequency of the VBI data extracting clock CK_{V} and during the other time periods at the frequency of the line lock clock CK_{L}. Here, the line lock clock CK_{L} is synchronous with the horizontal synchronization signal contained in the horizontal blanking interval of the analog composite video signal and has frequency of an integer, two or greater, multiple of the horizontal synchronization frequency fH.

The line lock clock CK_{L} is at 13.5 MHz that equals the sampling frequency conforming to the ITU-R BT.601 standard. The 13.5 MHz is equivalent to 858 times the horizontal synchronization frequency fH of the NTSC standard (858 fH) and 864 times the horizontal synchronization frequency fH of the PAL standard (864 fH).

The VBI data extracting clock CK_{V} is a clock signal synchronous with the CRI signal and the VBI data signal and has frequency equal to or frequency of an integer, two or greater, multiple of the frequency of the CRI signal and the VBI data signal. For example, for the NTSC standard, the frequency of the VBI data extracting clock CK_{V} is set at 364 times the horizontal synchronization frequency fH (364 fH). For the PAL standard, the frequency of the VBI data extracting clock CK_{V} is set at 444 times the horizontal synchronization frequency fH (444 fH).

The switching of the sampling frequency for the output signal of the re-sampling unit 13, in other words, the switching of the conversion ratio of the sampling frequency in the re-sampling unit 13 is performed according to phase information input from a selector 23. The details of the re-sampling by the re-sampling unit 13, the specific example configuration of the re-sampling unit 13, and the like will be described later.

An output processing unit 14 reads data of the digital component video signal (Y, Cr, Cb) re-sampled at the line lock clock CK_{L} and stored in memory (not shown) at the line lock clock CK_{L} and outputs the read data.

A VBI data extracting unit 15 has input thereto the luminance signal Y output from the re-sampling unit 13 which signal has been sampled at the VBI data extracting clock CK_{V} and extracts VBI data inserted at a predetermined position in the vertical blanking interval (e.g., the 12th through 14th lines of the vertical blanking interval in the example of FIG. 2). Because the VBI data signal is inserted in the form of an NRZ-coded pulse signal in the vertical blanking interval, with data sampled at the VBI data extracting clock CK_{V} having frequency of an integer multiple of the frequency of the VBI data signal being input, VBI data can be easily extracted by performing bit determination with a slice level as its reference.

A color burst phase detector 16 detects and holds phases of the color burst signal contained in the composite video signal. A burst lock clock generator 17 generates the burst lock clock CK_{B} synchronous in phase with the color burst signal based on the phases of the color burst signal detected by the color burst phase detector 16. The burst lock clock CK_{B} generated by the burst lock clock generator 17 is supplied to the A/D converter 10, the Y/C separation unit 11, the color demodulator 12, and the re-sampling unit 13 and used as their operation clock.

A horizontal sync (Hsync) phase detector 18 detects and holds phases of the horizontal synchronization signal contained in the composite video signal. A horizontal sync phase counter 19 counts up at the burst lock clock CK_{B} by an increment determined according to the frequency ratio of the line lock clock CK_{L} to the burst lock clock CK_{B}. That is, the output of the horizontal sync phase counter 19 is phase information indicating phase differences between the sampling points according to the burst lock clock CK_{B} and the sampling points according to the line lock clock CK_{L}. The horizontal sync phase counter 19 overflows in one period of the line lock clock CK_{L}.

A line lock clock generator 20 generates the line lock clock CK_{L} synchronous in phase with the horizontal synchronization signal using phase information output from the horizontal sync phase counter 19.

A VBI data phase detector 21 detects and holds phases of the VBI data signal from the CRI signal and the framing code inserted in the vertical blanking interval. A VBI data phase counter 22 counts up at the burst lock clock CK_{B} by an increment determined according to the frequency ratio of the VBI data extracting clock CK_{V} to the burst lock clock CK_{B}. That is, the output of the VBI data phase counter 22 is phase information indicating phase differences between the sampling points according to the burst lock clock CK_{B} and the sampling points according to the VBI data extracting clock CK_{V}. The VBI data phase counter 22 overflows in one period of the VBI data extracting clock CK_{V}.

The selector 23 selects either the phase information output from the horizontal sync phase counter 19 or the phase information output from the VBI data phase counter 22 and supplies the selected one to the re-sampling unit 13. The output signal of the selector 23 switches according to a phase information switching signal output by a timing generator 24.

The timing generator 24 detects a reference signal identifying the position of a VBI data inserted time period in which VBI data is inserted (the 12th through 14th lines of the vertical blanking interval in the example of FIG. 2). When having detected the reference signal, the timing generator 24 outputs the phase information switching signal to make the selector 23 output the output of the VBI data phase counter 22 during a time period including the VBI data inserted time period in which VBI data is inserted. The phase information switching signal is, for example, a binary signal that is at a high level during the VBI data inserted time period and at a low level during the other times as shown in FIG. 2.

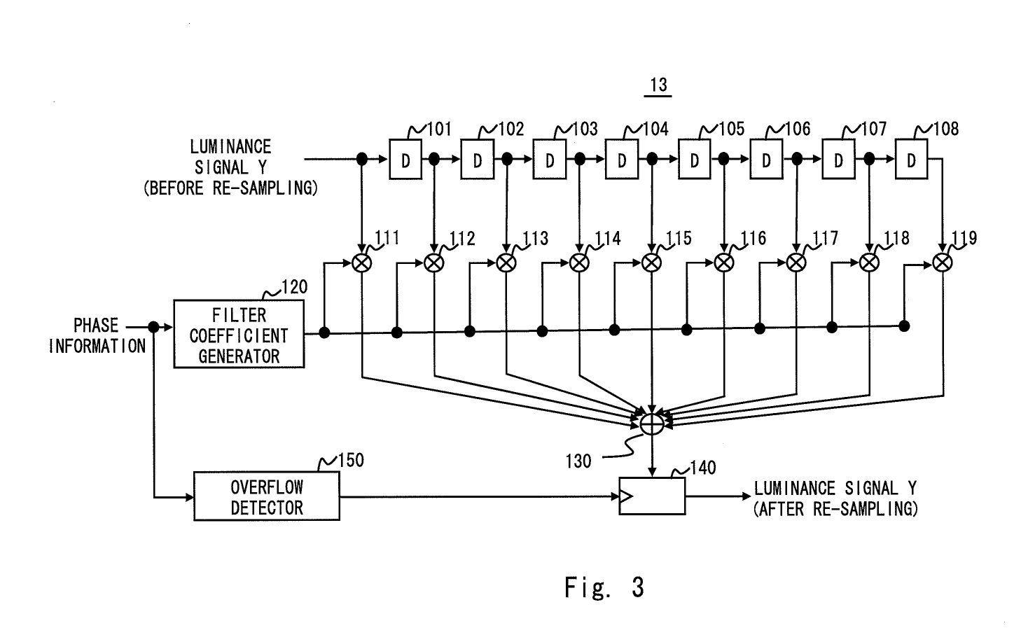

Next, the example configuration of the re-sampling unit 13 will be described. The re-sampling unit 13, which changes the sampling frequency of a digital signal, can be embodied by a digital filter performing interpolation, specifically, an interpolation filter constituted by an FIR (Finite Impulse Response) filter as shown, e.g., in FIG. 3. FIG. 3 shows an example configuration of the re-sampling unit included in the video signal processing apparatus according to the embodiment 1, which is a 9-tap FIR filter. In FIG. 3, a delay elements 101 to 108 are circuits that operate under the control of the burst lock clock CK_{B} to delay their input signal (the luminance signal Y in FIG. 3). Multipliers 111 to 119 multiply the values on the nine tap points by filter coefficients output from a filter coefficient generator 120.

The filter coefficient generator 120 generates the filter coefficients that are input to the multipliers 111 to 119 based on the phase information input from the selector 23. To be specific, the filter coefficient generator 120 generates reference filter coefficients from a sampling function (window function) such as a sinc function. Further, the filter coefficient generator 120 corrects the generated, reference filter coefficients for delays according to phase differences between the sampling points according to the burst lock clock CK_{B} and the sampling points according to the line lock clock CK_{L} or the VBI data extracting clock CK_{V} indicated by the phase information. By these processes, the filter coefficient generator 120 generates the filter coefficients with which to obtain interpolation points corresponding to the phase differences.

Alternatively, groups of filter coefficients to be applied corresponding to phase differences may be stored beforehand in nonvolatile memory (not shown), and the filter coefficient generator 120 may read the filter coefficients to be applied corresponding to the phase information from the nonvolatile memory (not shown) and supply to the multipliers 111 to 119. The groups of filter coefficients stored beforehand in the nonvolatile memory may be eight different groups of filter coefficients with which to obtain the interpolation points which divide the time period between the sampling points according to the burst lock clock CK_{B} into eight equal parts. In this case, the filter coefficient generator 120 may select the most suitable group from the eight different groups of filter coefficients according to the input phase information.

The outputs of the multipliers 111 to 119 are added by an adder 130. A latch register 140 takes in the output data of the adder 130 at the carry timing of the horizontal sync phase counter 19 or the VBI data phase counter 22 indicated by the phase information. A timing signal indicating the carry timings of the horizontal sync phase counter 19 or the VBI data phase counter 22 is generated by an overflow detector 150 monitoring the phase information and is input to the latch register 140.

The re-sampling unit 13 configured as shown in FIG. 3 can obtain signal values at the sampling points according to the line lock clock CK_{L} or the VBI data extracting clock CK_{V} by the interpolation using the sampling points according to the burst lock clock CK_{B}. The re-sampling unit 13 of FIG. 3 can switch the sampling frequency of its output data between the line lock clock CK_{L} and the VBI data extracting clock CK_{V} in response to a switch in the input phase information. Although FIG. 3 shows a circuit that re-samples the luminance signal Y, a re-sampling circuit for the color-difference signals Cr and Cb can also be configured in the same way as shown in FIG. 3. Needless to say, the example configuration of the re-sampling unit 13 shown in FIG. 3 is merely one example. For example, the re-sampling unit 13 may be an IIR (Infinite Impulse Response) type of interpolation filter.

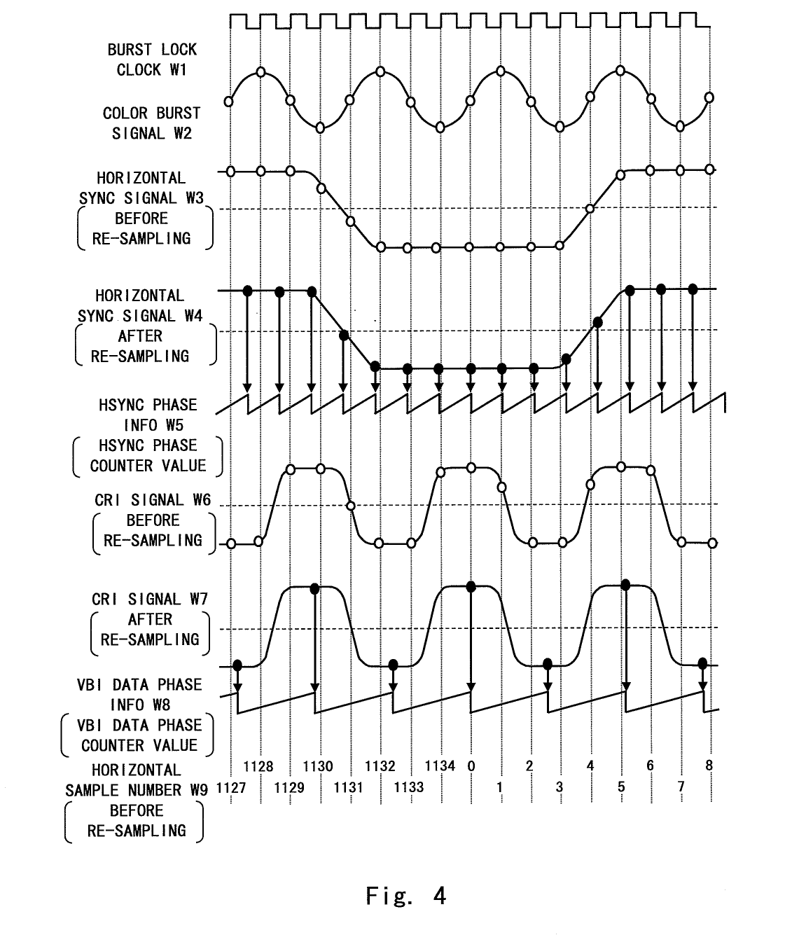

FIG. 4 is a signal waveform diagram of digital video signals in a video signal processing apparatus according to embodiment 1. To be specific, FIG. 4 shows signal waveforms before and after the re-sampling by the re-sampling unit 13 in the case where the composite video signal input to the video signal processing apparatus 1 is compliant with the PAL standard. Waveform W1 of FIG. 4 indicates the burst lock clock CK_{B}. In FIG. 4, the frequency of the burst lock clock CK_{B} is 4 f_{sc}. Waveform W2 of FIG. 4 indicates the color burst signal. The open circles on waveform W2 indicate the sampling points according to the burst lock clock CK_{B}.

Waveform W3 of FIG. 4 indicates the horizontal synchronization signal before the re-sampling by the re-sampling unit 13, that is, the horizontal synchronization signal sampled at the burst lock clock CK_{B}. Meanwhile, waveform W4 of FIG. 4 indicates the horizontal synchronization signal re-sampled by the re-sampling unit 13. That is, the sampling points indicated by the filled circles on waveform W4 are sampling points according to the line lock clock CK_{L}.

Waveform W5 of FIG. 4 indicates the horizontal sync phase information output from the horizontal sync phase counter 19. The falls of waveform W5 indicate carry timings in the horizontal sync phase counter 19. The re-sampling unit 13 outputs interpolated values upon these carry timings. In the example of FIG. 4 compliant with the PAL standard, the ratio of the frequency f_{CKL} of the line lock clock CK_{L} to the frequency f_{CKB} of the burst lock clock CK_{B} is given by f_{CKL}:f_{CKB}=864:(1135+4/625)=0.76123:1. Thus the horizontal sync phase counter 19 may count up by 0.76123 at each burst lock clock CK_{B}.

Waveform W6 of FIG. 4 indicates the CRI signal inserted before VBI data in the composite video signal. The open circles on waveform W6 indicate the sampling points according to the burst lock clock CK_{B}. Meanwhile, waveform W7 of FIG. 4 indicates the CRI signal re-sampled by the re-sampling unit 13. That is, the sampling points indicated by the filled circles on waveform W7 are sampling points according to the VBI data extracting clock CK_{V}.

Waveform W8 of FIG. 4 indicates the VBI data phase information output from the VBI data phase counter 22. The falls of waveform W8 indicate carry timings in the VBI data phase counter 22. The re-sampling unit 13 outputs interpolated values upon these carry timings. In the example of FIG. 4, the frequency f_{CKV} of the VBI data extracting clock CK_{V} is twice the VBI data signal frequency. The ratio of the frequency f_{CKV} of the VBI data extracting clock CK_{V} to the frequency f_{CKB} of the burst lock clock CK_{B} is given by f_{CKV}:f_{CKB}=444:(1135+4/625)=0.39118:1. Thus the VBI data phase counter 22 may count up by 0.39118 at each burst lock clock CK_{B}.

As described above, in the video signal processing apparatus 1 according to the present embodiment, the re-sampling unit 13 for converting the sampling frequency of the digital video signal from the burst lock clock CK_{B} to the line lock clock CK_{L} is configured to convert the sampling frequency to the VBI data extracting clock CK_{V} in the VBI data inserted time period. To be more specific, the video signal processing apparatus 1 controls the selector 23 through the phase information switching signal output from the timing generator 24. By this means, the phase information output from the VBI data phase counter 22 is input to the re-sampling unit 13 in the VBI data inserted time period, and in the other time periods, the phase information output from the horizontal sync phase counter 19 is input thereto. With this configuration, the video signal processing apparatus 1 can suppress the occurrence of false determination when extracting the VBI data without an increase in circuit scale.

Although the video signal processing apparatus 1 is configured to have the analog composite video signal input thereto and sample the signal by the A/D converter 10, it may be configured to have input thereto the digital composite video signal held in an external storage. In this case, the A/D converter 10 is unwarranted. Further, although a specific example has been described using FIG. 4 for the PAL standard, the present invention can be applied to other standards such as NTSC and SECAM.

It is apparent that the present invention is not limited to the above embodiment, but may be modified and changed without departing from the scope and spirit of the invention.

What is claimed is:

1. A video signal processing apparatus comprising:
a component video signal demodulator to demodulate a component video signal sampled by a burst lock clock signal from a composite video signal sampled by the burst lock clock signal, the burst clock signal having multiplied frequency of a color subcarrier in the composite video signal having an auxiliary digital data signal inserted therein; and
a re-sampling unit to convert sampling frequency of the component video signal selectively to a first frequency equal to or multiplied by horizontal synchronization frequency of the composite video signal or to a second frequency equal to or multiplied by frequency of the auxiliary digital data signal.

2. The video signal processing apparatus according to claim 1, wherein the auxiliary digital data signal is a VBI data signal contained in a vertical blanking interval of the composite video signal.

3. The video signal processing apparatus according to claim 1, further comprising a timing signal generator to generate a timing signal to instruct the re-sampling unit in a switching timing of the sampling frequency of the component video signal converted.

4. The video signal processing apparatus according to claim 2, further comprising a timing signal generator to generate a timing signal to instruct the re-sampling unit in a switching timing of the sampling frequency of the component video signal converted.

5. The video signal processing apparatus according to claim 3, wherein the timing signal generator outputs the timing signal in response to detecting a reference signal being capable of identifying an insert position of the auxiliary digital data signal from the composite video signal.

6. The video signal processing apparatus according to claim 1, wherein the component video signal demodulator performs Y/C separation and color demodulation and stops the Y/C separation during a predetermined time period including an insert period of the auxiliary digital data signal.

7. The video signal processing apparatus according to claim 2, wherein the component video signal demodulator performs Y/C separation and color demodulation and stops the Y/C separation during a predetermined time period including an insert period of the auxiliary digital data signal.

8. The video signal processing apparatus according to claim 3, wherein the component video signal demodulator performs Y/C separation and color demodulation and stops the Y/C separation during a predetermined time period including an insert period of the auxiliary digital data signal.

9. The video signal processing apparatus according to claim 5, wherein the component video signal demodulator performs Y/C separation and color demodulation and stops the Y/C separation during a predetermined time period including an insert period of the auxiliary digital data signal.

10. The video signal processing apparatus according to claim 6, wherein the predetermined time period is a vertical blanking interval.

11. The video signal processing apparatus according to claim 1, further comprising an auxiliary digital data extracting unit to extract the auxiliary digital data signal from the component video signal re-sampled by the re-sampling unit at multiple frequency of auxiliary digital data signal frequency.

12. The video signal processing apparatus according to claim 2, further comprising an auxiliary digital data extracting unit to extract the auxiliary digital data signal from the component video signal re-sampled by the re-sampling unit at multiple frequency of auxiliary digital data signal frequency.

13. The video signal processing apparatus according to claim 3, further comprising an auxiliary digital data extracting unit to extract the auxiliary digital data signal from the component video signal re-sampled by the re-sampling unit at multiple frequency of auxiliary digital data signal frequency.

14. The video signal processing apparatus according to claim 5, further comprising an auxiliary digital data extracting unit to extract the auxiliary digital data signal from the component video signal re-sampled by the re-sampling unit at multiple frequency of auxiliary digital data signal frequency.

15. The video signal processing apparatus according to claim 6, further comprising an auxiliary digital data extracting unit to extract the auxiliary digital data signal from the component video signal re-sampled by the re-sampling unit at multiple frequency of auxiliary digital data signal frequency.

16. The video signal processing apparatus according to claim 10, further comprising an auxiliary digital data extracting unit to extract the auxiliary digital data signal from the component video signal re-sampled by the re-sampling unit at multiple frequency of auxiliary digital data signal frequency.

17. A re-sampling apparatus which converts a sampling frequency of a digital video signal, comprising:
re-sampling means to convert the sampling frequency of the digital video signal selectively to a first frequency or to a second frequency, the first frequency being multiple a horizontal synchronization frequency of the digital video signal, and the second being multiple of the frequency of an auxiliary digital data signal inserted in a vertical blanking interval of the digital video signal; and
instructing means to instruct the re-sampling means to switch the sampling frequency in response to detecting a reference signal being capable of identifying an insert position of the auxiliary digital data signal.
